(19) United States
(12) Patent Application Publication
(10) Pub. No.: US 2007/0240139 A1
(43) Pub. Date: Oct. 11, 2007

(54) IMAGE PROCESSING DEVICE AND IMAGE PROCESSING METHOD

(75) Inventor: Yoshihiro Osada, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/277,616

(22) Filed: Mar. 28, 2006

(51) Int. Cl. G06F 9/45

(52) U.S. Cl. 717/146

(57) ABSTRACT

An image processing device is disclosed that simplifies computations (a drawing process) when storing output image data that is created based on intermediate language data in the drawing region, by rearranging the address matrix of a drawing region in a main memory, and thus comprehensively increases the speed of image processing. The image processing device includes a main memory having a drawing region in which output image data corresponding to at least one band region is stored, and a memory control unit that rearranges the address matrix of the drawing region based on a prescribed rule, creates output image data based on band intermediate language data, and sequentially stores the created output image data in one word units in the drawing region whose addresses are rearranged.

### CROSS-REFERENCE TO RELATED APPLICATIONS

This application claims priority to Japanese Patent Application No. 2005-090687. The entire disclosure of Japanese Patent Application No. 2005-090687 is hereby incorporated herein by reference.

### BACKGROUND OF THE INVENTION

1. Field of the Invention

The present invention relates to an image processing device that converts a plurality of band regions in one page of print data into intermediate language data, and sequentially creates and outputs output image data in accordance with the intermediate language data for each of the plurality of the converted band regions. In particular, the present invention relates to an image processing device that can increase the overall speed of image processing by simplifying the computation process (the drawing process) used when storing the output image data that is created from the intermediate language data in a drawing region such as a main memory. In addition, the present invention relates to an image processing method that is performed by this image processing device.

2. Background Information

A heretofore known image processing device, such as a printer, performs image formation by receiving one page of Page Description Language data (PDL data) that is transferred from a host computer (hereinafter called a host PC), converting the PDL data into intermediate language data, creating output image data such as bitmap data while interpreting the converted intermediate language, and outputting the output image data to an image creation control unit (an engine control unit). This data processing method is used in an electrophotographic printer (e.g., a laser printer or a LED printer). Note that this printer will be hereinafter referred to as a “page printer.”

This type of page printer must, at a minimum, include a main memory having sufficient capacity to store one page of bitmap data created from PDL data. However, demands for high-capacity main memory have risen as the resolution of image data has increased.

On the other hand, a band division method is known which reduces the capacity of the main memory. This method is disclosed in Japan Patent Application Publication 2001-249774 (technological background section). Referring now to FIGS. 6 and 7, image processing in which the band division method is applied will be briefly described below, on the assumption that print output to a printer is conducted for one page of image data 40 shown in FIG. 6 and created in a host PC. As shown in FIG. 6., the image data 40 is an example of image data that will be output and printed, and in which the text characters “AB” and “CD” are drawn along the upper left corner in the vertical direction (i.e., the sub-scanning direction). In addition, FIG. 7 shows the PDL data divided into a plurality of band regions. Furthermore, the size of the image data 40 shown in FIG. 6 is vertical A4 size, but the lower portion is not shown in the figure.

When the image data 40 is converted into PDL data on the host PC side and transferred to a printer, the transferred PDL data will be converted into intermediate language data on the printer side. Furthermore, as shown in FIG. 7, the converted intermediate language data will be divided into a plurality of band regions B1, B2, . . . . Then, sequential bitmap data is created for each of the band regions, and is drawn (stored) in the drawing region of sequential main memory. Next, the band units of the bitmap data that are stored in the drawing region are sequentially read out, and then output and printed.

Thus, when the band division method is used, the capacity of the main memory can be reduced to at least the capacity that corresponds to a band region.

In addition, Japan Patent Application Publication 2001-249774 discloses an improved version of the band division method, in which band regions are further divided into sub-band regions, and each of the sub-band regions is sequentially processed.

Note that when data is to be read out from or written to the main memory, a heretofore known cache process is generally performed by using a cache memory that can be accessed faster than the main memory, thereby allowing high speed data processing to be achieved.

However, as described below, if the band division method is used, the number of times that the cache process will be performed when drawing (storing) the bitmap data in the main memory will increase, and this will prevent the speed of the drawing process from increasing.

For example, assume a situation in which bitmap data created based upon the intermediate language data 101 of the band region B1 (see FIG. 7) is drawn in a drawing region 70 (storage regions A0-A31) in the main memory shown in FIGS. 8A and 8B. Here, the storage region located at one address (memory address) in the drawing region 70 has a one word capacity. In other words, the drawing region 70 is assumed to be a storage region having a thirty two word capacity.

In addition, the cache memory is assumed to have an eight word capacity. Here, FIG. 8A shows the band region B1 drawn in the drawing region 70, when the drawing region 70 in the main memory is assumed to be a drawing canvas. FIG. 8B shows the address matrix of the drawing region 70 in the main memory.

The cache process normally uses the characteristic that states that there is a high probability that addresses near an address accessed once will be accessed again during data reading and writing. For example, when an address A0 is accessed in order to write data thereto, an eight word portion (the capacity of the cache memory) of storage regions A0-A7 from address A0 onward will be overwritten in the cache memory as a single unit, and then data will be written thereto. Data reading will of course be conducted in the same way.

In this case, in the example shown in FIGS. 8A and 8B, the data to be drawn is at addresses A0 to A2, and thus that data is written into the cache memory. At this point, data to be written does not exist at addresses A3 to A7. Therefore, the three word portion written to the cache memory (A0 to A2), and the five word portion not written to the cache memory (A3 to A7) are returned to the drawing region 70 in the main memory. Because of this, new bitmap data is drawn only in addresses A3 to A7.

The next eight word portion in addresses A8 to A15 are moved to the cache memory, and the bitmap data is drawn in addresses A8 to A10 in the same way. The same type of processing is conducted with respect to addresses A16 to A23 and A24 to A31 to thereby draw the bitmap data corresponding to the band region B1. Therefore, when the bitmap data is to be drawn in the drawing region 70 based on the intermediate language data 101 of the band region B1 (see FIG. 7), the cache process will be conducted a total of four times. In addition, when the image data 40 shown in FIG. 6 is divided into a total of N band regions, for example, the cache process will be conducted 4×N times. This is because the addresses of the image region in the main memory are sequentially allocated in the main scanning direction (i.e., the horizontal direction shown in FIG. 8A).

However, when bitmap data is to be drawn in the drawing region 70, data on the background color (e.g., white background color) is normally stored in the address regions in which no other data is stored (A3 to A7, A11 to A15, A19 to A23, and A27 to A31). Therefore, there is no need to access these address regions, and only the regions in which there is data to be drawn (A0 to A2, A8 to A10, A16 to A18, and A24 to A26) will be accessed and data written thereto. However, as described above, the cache process is conducted with respect to one line (eight words) of data in the main scanning direction as a single unit, and thus the CPU has no choice but to access addresses that it has no need to access. Wasteful cache processes and memory access are unnecessarily performed.

For example, in an image in which a sentence is displayed in the horizontal direction, when the left edge portion and the right edge portion of the image are compared, there is clearly a high possibility that characters will be more aggregated on the left edge portion of the image than on the right edge portion thereof because the sentence is written from the left corner toward the right. Therefore, when the data to be drawn is an aggregated image, such as an image of a sentence written in the horizontal direction, and that data is divided into a plurality of band regions in the vertical direction, the number of times that the CPU will access regions that it has no need to access will multiply during the cache process if the process is sequentially conducted from the left edge in the main scanning direction to the right edge.

In view of the above, it will be apparent to those skilled in the art from this disclosure that there exists a need for an improved image processing device, and an image processing method, that can comprehensively increase the speed of image processing by simplifying the computation process (drawing process) when storing output image data created from the intermediate language data in the drawing region by means of changing the address matrix of the drawing region in the main memory and the like. This invention addresses this need in the art as well as other needs, which will become apparent to those skilled in the art from this disclosure.

### SUMMARY OF THE INVENTION

The present invention is applied to an image processing device that converts one page of print data (PDL data) written in a predetermined language into band intermediate language data for each of a plurality of band regions, and outputs output image data such as bitmap data and the like that is created based on the converted band intermediate language data. The image processing device is comprised of a data storage unit having a drawing region in which output image data corresponding to at least one band region is stored, an address rearrangement unit that rearranges the addresses of the drawing region based on a predetermined rule, and an output image data creation storage unit that creates the output image data based on the band intermediate language data and sequentially stores the created output image data in single word units in the drawing region whose addresses are rearranged by the address rearrangement unit.

In general, high speed data processing such as cache processing is performed during image processing. Therefore, the drawing process performed when the output image data is to be stored (drawn) in the drawing region will be simplified by rearranging the addresses as described above. Specifically, the number of times that high speed data processing is performed during the drawing process will be reduced. Because of this, the speed of the drawing process can be increased, and the speed of image processing can be comprehensively increased.

In this case, it is preferable to rearrange the address matrix in the main scanning direction in the drawing region to the sub scanning direction, so that the output image data can be sequentially aligned and stored in the drawing region in single word units in the sub scanning direction. More specifically, when the drawing region is considered to be a drawing canvas, the address matrix of the image to be drawn in the main scanning direction will be rearranged to the matrix in the sub scanning direction. As described above, the number of times that high speed data processing is performed will be reduced to a minimum by rearranging the addresses of the drawing region. As a result, the speed at which drawing is performed in the drawing region will be further increased.

Here, when the image processing device is further comprised of a high speed data storage unit, such as a cache memory, that has a storage capacity smaller than the capacity of the data storage unit and which enables high speed data access, the created output image data can be temporarily stored in the high speed data storage unit in each storage capacity unit thereof, and furthermore, the output image data stored in the high speed data storage unit can be stored in the drawing region. High speed data processing such as cache processing can be achieved by means of this structure. As a result, an increase in the speed of the drawing process and image processing can be specifically achieved.

In addition, the present invention is applied to an image processing method conducted in an image processing device that converts one page of print data (PDL data) written in a predetermined language into band intermediate language data for each of a plurality of band regions, and outputs output image data such as bitmap data and the like that is created based on the converted band intermediate language data. The image processing method includes a data storage step in which output image data corresponding to at least one band region is stored in a drawing region, an address rearrangement step that rearranges the addresses of the drawing region based on a predetermined rule, and an output image data creation storage step that creates the output image data based on the band intermediate language data and sequentially stores the created output image data in single word units in the drawing region whose address is rearranged by the address rearrangement unit.

According to the present invention, because the addresses of the drawing region are rearranged, the number of times that high speed data processing, such as cache processing performed in the drawing process, will be reduced. Because of this, the drawing process will be simplified. As a result, the speed of the drawing process can be increased, and the speed of image processing can be comprehensively increased.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block chart showing a first embodiment of an image processing device of the present invention.

FIG. 2 shows a heretofore known address matrix and the address matrix of the present invention.

FIG. 3A shows an image corresponding to one band region B1 when drawn in a drawing region 30 of a main memory 3, and FIG. 3B shows an address matrix of the drawing region 30 in the main memory 3.

FIG. 4 is a flow chart that describes the steps of the drawing process executed by a memory control unit in an image processing device of the present invention.

FIG. 5 is a block chart showing another embodiment of an image processing device of the present invention.

FIG. 6 shows an example of image data that will be output for printing.

FIG. 7 shows PDL data divided into a plurality of band regions.

FIGS. 8A-8B show an image corresponding to one band region B1 which is drawn in the drawing region 70 of the main memory, and an address matrix of the drawing region 70 in the main memory, in accordance with a heretofore known method.

### DETAILED DESCRIPTION OF THE PREFERRED EMBODIMENTS

Selected embodiments of the present invention will now be described with reference to the drawings. It will be apparent to those skilled in the art from this disclosure that the following descriptions of the embodiments of the present invention are provided for illustration only, and not for the purpose of limiting the invention as defined by the appended claims and their equivalents.

### First Embodiment

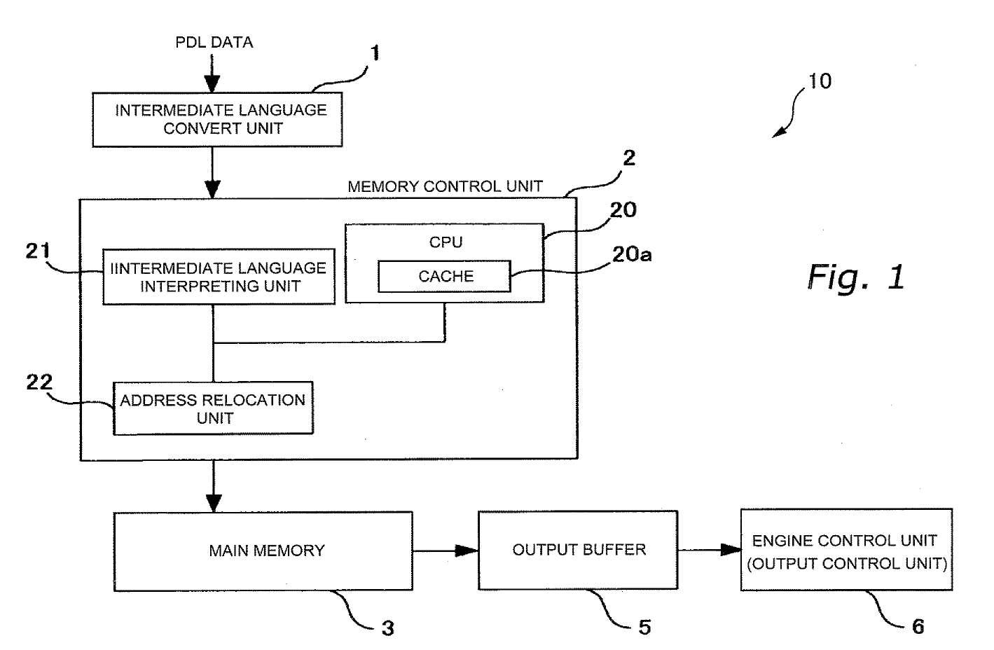

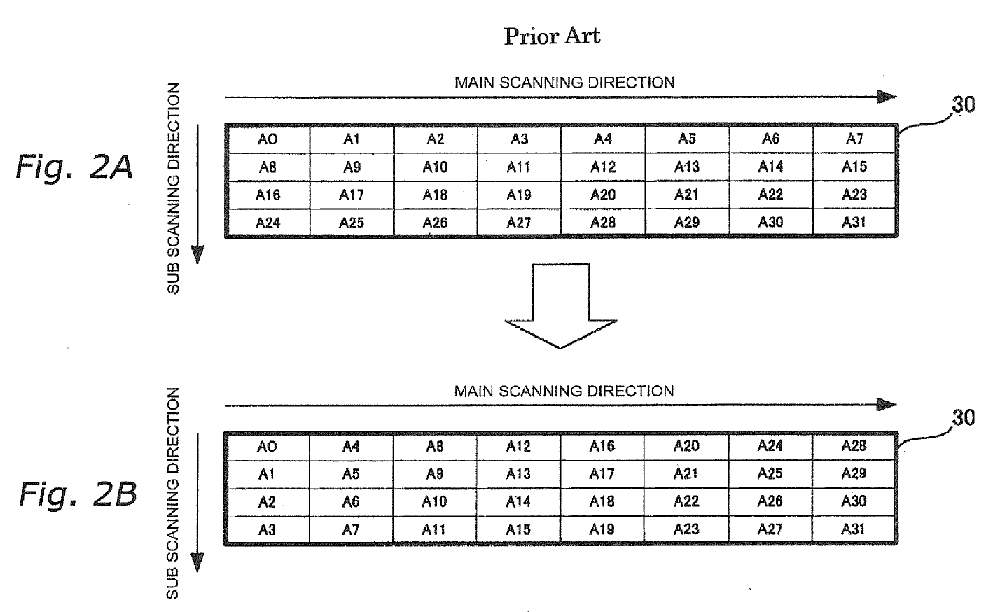

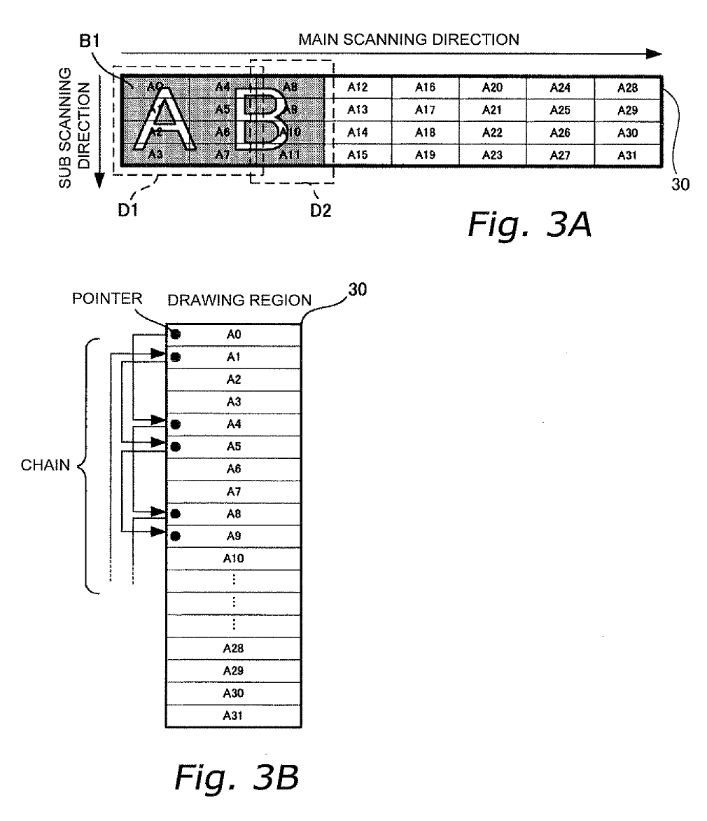

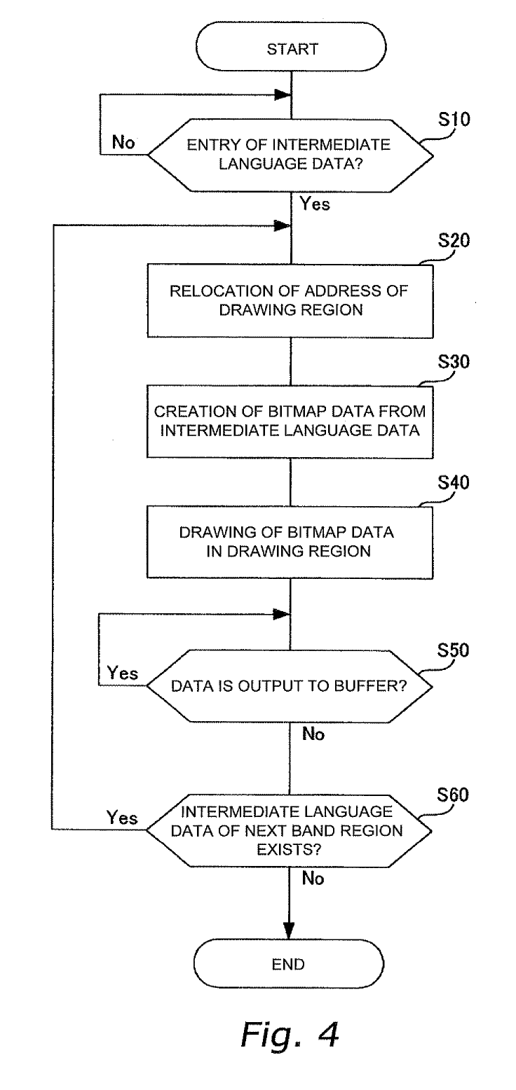

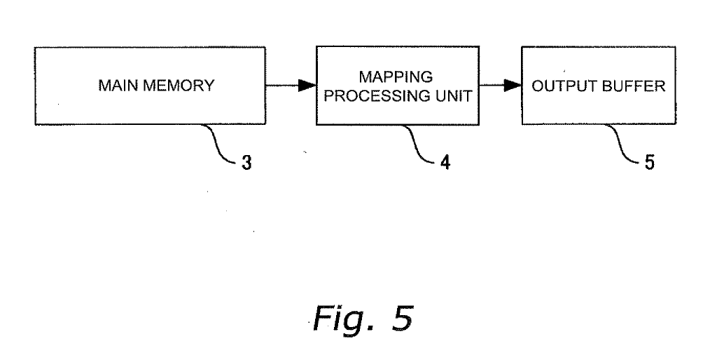

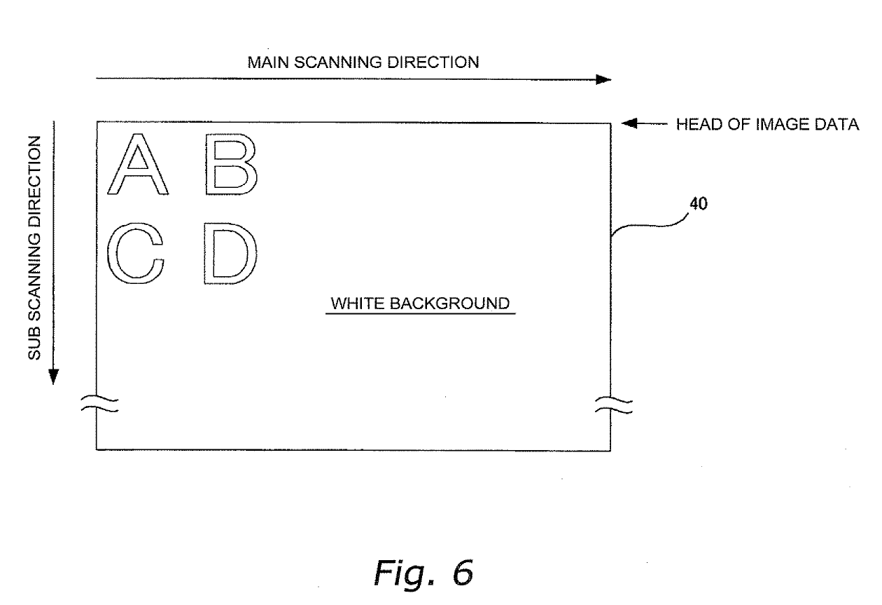

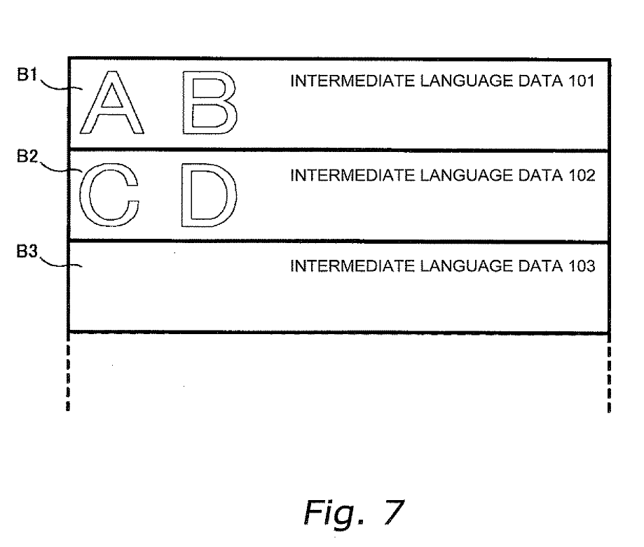

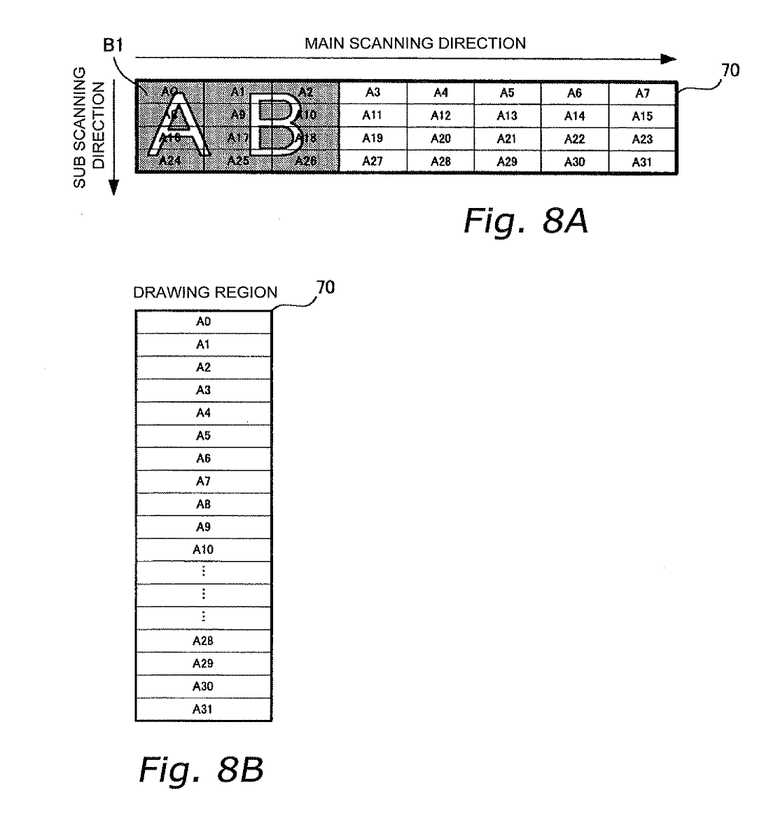

FIG. 1 is a block chart showing an embodiment of an image processing device of the present invention. FIG. 2 shows a heretofore known address matrix and the address matrix of the present invention. FIGS. 3A-3B show address matrices when an image corresponding to one band region B1 is drawn in a drawing region of main memory. FIG. 4 is a flow chart that describes the steps of the drawing process executed by a memory control unit in an image processing device of the present invention. FIG. 5 is a block chart showing another embodiment of an image processing device of the present invention. FIG. 6 shows an example of image data that is to be output for printing. FIG. 7 shows PDL data divided into a plurality of band regions. FIG. 8A-8B show address matrices when an image corresponding to one band region B1 is drawn in the drawing region of main memory in accordance with a heretofore known method.

First, the block chart shown in FIG. 1 will be used to describe the schematic structure of an image processing device 10 according to the present embodiment. FIG. 1 is a block chart showing the processing control system of the image processing device 10. Note that a printer, a multifunction peripheral (MFP) having the functions of a printer, or the like, correspond to the image processing device 10 of the present invention. The image processing device 10 of the present invention converts one page of PDL data (corresponding to print data) that is expressed in PDL (Page Description Language) to band intermediate language data for each of a plurality of band regions, and then outputs bitmap data (output image data) that is created based on this converted band intermediate language data.

As shown in FIG. 1, the image processing device 10 is comprised of an intermediate language conversion unit 1, a memory control unit 2, a main memory 3 (an example of the data storage unit), an output buffer 5, and an engine control unit 6. Note that in the present embodiment, the intermediate language conversion unit 1 is described as hardware such as an application specific integrated circuit (ASIC) or the like comprised of hard logic. However, the intermediate language conversion unit 1 may be achieved by performing computations based on a predetermined program in an image processing control unit of the CPU (not shown in the drawings).

The intermediate language conversion unit 1 receives one page of PDL data transferred from a host computer connected to a network such as a LAN, divides the received data into a plurality of band regions, and then sequentially converts the plurality of band regions into the intermediate language data from the beginning of the PDL data. More specifically, the one page of transferred and input PDL data is temporarily converted into intermediate language data, and the converted data is stored in an embedded memory (not shown in the drawings) included in the intermediate language conversion unit 1. Then, the converted intermediate language data is divided into a plurality of band regions sequentially from the beginning of the image.

FIG. 6 shows image data 40 in which only the text characters “AB” and “CD” have been drawn in the upper left corner along the vertical direction of an A4 sized document. In addition, FIG. 7 shows a plurality of band regions B1, B2, . . . , which are the PDL data of the image data 40 in FIG. 6 divided along the vertical direction of an A4 sized document.

In the description of the embodiments below, an example will be used in which the PDL data of the image data 40 shown in FIG. 6 is transferred, divided into a plurality of band regions as shown in FIG. 7, and then subjected to a drawing process. Of course, the present invention is not limited to this example.

The main memory 3 is a memory device such as a readable and writable dynamic RAM (DRAM) and synchronous DRAM (SDRAM). The bitmap data that is created based on the intermediate language data converted in the intermediate language conversion unit 1 is stored in the main memory 3. Therefore, a drawing region 30 (shown in FIGS. 2, 3A, and 3B) in which the created bitmap data is stored (drawn) will be maintained in the main memory 3. Note that the main memory 3 is provided as an example of a data storage unit. However, large capacity storage media such as a HDD may be used instead of the main memory 3. In the present embodiment, bitmap data is created for each of the plurality of band regions divided in the intermediate language conversion unit 1, and stored in the drawing region 30. Therefore, it is sufficient if the drawing region 30 has the capacity to store bitmap data corresponding to at least one band region.

In the present embodiment, as shown in FIGS. 2 and 3A, the drawing region 30 is assumed to have a capacity of 32 words, i.e., a matrix comprising eight words in the main scanning direction and four words in the sub scanning direction. In addition, as described below, a cache 20a is assumed to have a capacity of eight words.

Here, FIG. 3A shows an image corresponding to one band region B1 drawn in the drawing region 30 on the assumption that the drawing region 30 in the main memory 3 is a drawing canvas, and FIG. 3B shows the address matrix of the drawing region 30 in the main memory 3.

The memory control unit 2 is comprised of an intermediate language interpreting unit 21, an address rearrangement unit 22, and a CPU 20 that controls these units and writes (draws, stores) the bitmap data to the main memory 3 and reads out the bitmap data from the main memory 3. Note that the intermediate language interpreting unit 21 and the CPU 20 are examples of the output image data storage unit.

In the present embodiment, the intermediate language interpreting unit 21 and the address rearrangement unit 22 are described as a circuit board or an IC, either of which is comprised of hard logic or the like. However, the processing conducted in these units may be conducted by a program stored in the CPU 20.

A cache process is executed by the CPU 20 for the purpose of increasing the speed at which data is read from and written to the main memory 3. Therefore, a cache memory 20a such as an SRAM (Static RAM) or the like having a small capacity is provided in the CPU 20, and can be accessed faster than the main memory 3. The cache memory 20a is an example of a high-speed data storage unit and hereinafter referred to as a “cache.” The cache 20a may be any memory that allows data to be accessed faster than the main memory 3. Therefore, if a HDD whose data access speed is slower than that of the main memory 3 is used instead of the main memory 3, not only can an SRAM that is faster than the HDD be used as the cache memory, but a DRAM, an SDRAM, and the like can also be used as the cache memory.

The intermediate language interpreting unit 21 creates the bitmap data based on the intermediate language data that is converted by the intermediate language conversion unit 1 for each of the plurality of band regions. When the intermediate language data is the band region B1 data (see FIG. 7), the image data “AB”, the position data of the image data “AB” in the band region B1, and data on the white background that is the area other than the image “AB”, are at least included in the intermediate language data. Thus, in this case, the bitmap data is created by interpreting (decoding) the data in the intermediate language interpreting unit 21.

The address rearrangement unit 22 performs an address rearrangement process, in which the address of the drawing region 30 in the main memory 3 is rearranged based on a predetermined rule. This address rearrangement process is conducted before the bitmap data is drawn (stored) in the drawing region 30 by the CPU 20. As shown in FIG. 2A, the address matrix of the drawing region 30 in the main memory 3 is sequentially arranged in the main scanning direction (the horizontal direction). However, in the present embodiment, the address matrix of the drawing region 30 arranged in the main scanning direction is rearranged to the sub scanning direction by the address rearrangement unit 22, so that the bitmap data created by the intermediate language interpreting unit 21 can be sequentially aligned and stored in one word units in the drawing region 30 in the sub scanning direction. In other words, a process is performed which rearranges the address matrix shown in FIG. 2A to the address matrix shown in FIG. 2B. Here, a drawing region 30 whose addresses are arranged in a heretofore known address matrix is shown in FIG. 2A, and a drawing region 30 whose addresses are rearranged by the address rearrangement unit 23 is shown in FIG. 2B.

For example, as shown in FIG. 3B, rearrangement of the addresses by the address rearrangement unit 22 is performed by a heretofore known chain pointer method in which chains and pointers are used. In the chain pointer method, a stored descriptor region in which data on the addresses to be subsequently accessed and the start address is prepared in advance in a storage region such as the main memory 3, and a pointer that links to this descriptor region is attached to each of the addresses of the drawing region 30. Because of this, when an address is accessed, data on the descriptor region that is linked to the pointer attached to this accessed address is referenced, and thus the address to be subsequently accessed can be determined. Linking between addresses in this way is referred to as “linking a chain.”

By using this method, if a chain is linked between the pointers attached to each address so as to follow the rule “address A0, A4, A8, . . .” in the drawing region 30, the access sequence used by the CPU 20 when accessing the drawing region 30 to store data will be determined by the pointers and chain. Thus, by changing the sequence at which the drawing region 30 is accessed, the addresses of the drawing region 30 shown in FIG. 2A will appear to be rearranged to the addresses of the drawing region 30 shown in FIG. 2B and FIG. 3A.

In addition, the function of Formula 1 below that converts an address to be accessed may be used instead of the chain pointer method.
F(x)=Gₐ(x)·b+Hₐ(x) (1)

In Formula 1, “F(x)” is the post-conversion address.

“x” is the address that is to be accessed by the CPU 20 when storing data in the drawing region 30. “a” is the unit data alignment number in the main scanning direction of the image data that is to be drawn in one band region, and “b” is the unit data alignment number in the sub scanning direction of the image data that is to be drawn in one band region. “Gₐ(x)” represents the remainder when dividing “x” by “a,” and “Hₐ(x)” represents the quotient when dividing “x” by “a.” Note that in the present embodiment, the unit data indicates data on the capacity of one word portion.

By using the function F(x) in the address rearrangement unit 22, an address that is to be accessed by the CPU 20 when storing data in the drawing region 30 will be converted by the function F(x), and thus the rearrangement of the address will be achieved.

For example, when the drawing region 30 having the 4×8 matrix of words shown in FIG. 2 is accessed, the function F(x) is expressed by setting “a” to 8 and “b” to 4 as shown in Formula 2 below.
F(x)=G₈(x)·4+Hₛ(x) (2)

According to Formula 2, the addresses (A01 to A31) that are to be accessed in the drawing region 30 will be converted as shown below:
F(0)=G₈(0)·4+H₈(0)=0·4+0=0 (A0)
F(1)=G₈(1)·4+H₈(1)=1·4+0=4 (A4)
F(2)=G₈(2)·4+H₈(2)=2·4+0=8 (A8)
F(8)=G₈(8)·4+H₈(8)=0·4+1=1 (A1)
F(9)=G₈(9)·4+H₈(9)=1·4+1=5 (A5)
F(16)=G₈(16)·4+H₈(16)=0·4+2=2 (A2)
F(17)=G₈(17)·4+H₈(17)=1·4+2=6 (A6)

Note that the rearrangement of the addresses is not limited to the chain pointer method and the formula F(x), and various other types of methods can also be used.

The buffer 5 includes a FIFO memory, and sequentially outputs the bitmap data that is transferred from the drawing region 30 to the engine control unit 6.

In addition, the engine control unit 6 performs control in order to form an image in accordance with the bitmap data output from the output buffer 5.

Next, referring to FIGS. 3A-3B, 6, and 7, an example of the image processing steps performed by the memory control unit 2 and shown in the flowchart of FIG. 4 will be described. S10, S20, . . . shown in FIG. 4 are the process step numbers, and the process starts from S10.

As described above, when the PDL data of the image data 40 shown in FIG. 6 is transferred from the host PC, and divided into a plurality of band regions B1, B2, . . . in the intermediate language conversion unit 1 (see FIG. 1), the intermediate language conversion unit 1 will sequentially output the intermediate language data from the band region B1 at the beginning of the image to the memory control unit 2.

Thus, when the intermediate language data is output, the CPU 20 in the memory control unit 2 will determine whether or not the intermediate language data 101 of the band region B 1 (see FIG. 7) is input from the intermediate language conversion unit 1 (step S10).

Then, if the input of the intermediate language data 101 is confirmed, the CPU 2 will order the address rearrangement unit 22 to rearrange the address matrix of the drawing region 30 in the main memory 3 as shown in FIG. 2B (step S20).

Next, the intermediate language data 101 that was input is transferred to the intermediate language interpreting unit 21 by the CPU 20, and bitmap data will be created based on the intermediate language data 101 in the intermediate language interpreting unit 21 (step S30). In the case of the band region B1, for example, the bitmap data that will be created is background color (white color) image data and “AB” image data.

The bitmap data created in the intermediate language interpreting unit 21 is sequentially drawn (stored) from the storage region located in address A0 in the drawing region 30 by the CPU 20.

This drawing processing is conducted as follows. First, the background color (white color) image data is stored in all the addresses of the drawing region 30.

Then, a first cache process is performed in order to store the “AB” image data in the drawing region 30. More specifically, the content of addresses A0 to A7 (eight words in the present embodiment) are temporarily read (stored) into the cache 20a beginning from address A0, and thus image data D1 (see FIG. 3A) will be transferred to cache 20a.

In a heretofore known method, the addresses of the drawing region are aligned in the main scanning direction as shown in FIG. 2A. However, in the present embodiment, because the addresses in the drawing region are aligned in the sub scanning direction (the vertical direction), there will be data that is to be written to all addresses A0 to A7 read by the cache 20a. Therefore, data will be transferred to all addresses A0 to A7 read by the cache 20a. Note that the cache hit ratio here is 100%.

If the transfer of the image data D1 is completed, the data in the cache 20a will be returned to the addresses A0 to A7 of the drawing region 30. Thus, the image data D1 will be drawn in the addresses A0 to A7 of the drawing region 30.

Next, a second cache process will be performed. In other words, an eight word portion in addresses A8 to A15 will be read into cache 20a beginning from address A8, and in the same way as noted above, image data D2 (see FIG. 3A) will be transferred to the cache 20a. In this case, data is transferred to addresses A8 to A11. Note that the cache hit ratio is 50%. If the transfer of this data is completed, the data in the cache 20a will be returned to the addresses A8 to A15. Thus, the image data D2 will be drawn in the addresses A8 to A11 in the drawing region 30. Because data that is not transferred will be returned as is to the addresses A12 to A15, white background image data that was previously drawn will be stored as is in these addresses.

Thus, because the image “AB” to be drawn will be drawn by the second cache process, there is no need for the CPU 20 to access the drawing region 30 thereafter. In other words, because an image to be drawn in the addresses A16 to A31 does not exist, access to these addresses will not be conducted. Therefore, a third or subsequent cache process will not be performed.

Bitmap data corresponding to the band region B1 will be drawn in the drawing region 30 by means of the drawing process described above. Thus, in the present embodiment, because a drawing process that includes a cache process having a high hit ratio is performed in the drawing region 30 whose addresses are rearranged, bitmap data can be drawn (stored) in the drawing region 30 without conducting a large number of cache processes having a low hit ratio (four times in the example above) as in the prior art. Because of this, the speed of the drawing process will be increased.

Next, when the drawing process of the bitmap data corresponding to the band region B1 is completed in step S40, it will be determined whether or not the data in the drawing region 30 has been transferred to the output buffer 5 (step S50). If the data is transferred to the output buffer 5, it will be determined whether or not the intermediate language data of the subsequent band regions has been input (step S60). Here, if the intermediate language data in the subsequent band region B2 is determined to have been input, the process from step S20 will be repeated, and the drawing process for the image “CD” to be drawn will be executed. Thus, if the drawing process with respect to the intermediate language data for all band regions is completed, and the intermediate language data is no longer being input, the series of processes will be completed.

Note that the image data 40 shown in FIG. 6 used in the present embodiment does not include images to be drawn in the band region B3 and thereafter, and thus steps S20 to S40 will be omitted. In other words, even if intermediate language data in the subsequent band regions are input, the process from step S50 will be repeated without performing the process of steps S20 to S40 when it is determined that data to be drawn does not exist. Because of this, useless address rearrangement processes that are performed when data to be drawn does not exist will be omitted, and thus the speed of the drawing process can be increased.

### Second Embodiment

In the first embodiment, the read-out process of the bitmap data that is drawn (stored) in the drawing region 30 (the process of data output to the output buffer 5) will be performed by accessing the drawing region 30 in the order in which the addresses were rearranged. In other words, the read-out process is performed in the order in which the addresses were rearranged, not only during the drawing process of the bitmap data, but also during the read-out process of the bitmap data.

However, the process in which a remote address is accessed is more complex than the process in which a sequential address or the an adjacent address is accessed, and thus a great deal of processing time is needed.

In this case, as shown in FIG. 5, it is preferred that a mapping process unit 4 that maps the bitmap data transferred from the main memory 3 be provided, and that the bitmap data is read out sequentially beginning from address A0 of the main memory 3, and transferred to the mapping process unit 4, after the chains and the pointers linked to the drawing region 30 by the CPU 20 are removed or invalidated.

Note that when the address rearrangement process is performed by using the function F(x) of Formula 1 in the address rearrangement unit 22, it is preferred that the bitmap data is sequentially read out beginning from address A0 and transferred to the mapping process unit 4 when the data is to be read out from the drawing region 30.

Due to this configuration, the read-out process from the drawing region 30 in the main memory 3 is sequentially performed from the initial address A0 (A1, A2, . . . ) without being limited by the chains, and thus the speed of the read-out process will not be reduced.

If the mapping process unit 4 is comprised of hardware such as an ASIC that includes a mapping circuit or an internal memory, and the mapping process unit 4 performs mapping of an image fragment of a single word unit which was divided when the image was read out in the sequence A0, A1, A2 . . . , the mapping will be performed without any involvement of the CPU 20, and the CPU 20 will only transfer the bitmap data to the mapping processor 4. Therefore, the CPU 20 can perform other processes, such as the address rearrangement process, while the mapping process is being performed. Because of this, the read-out process of the bitmap data will be performed without delay, and the speed of the process from the drawing process to the read-out process can be increased.

### Third Embodiment

In the first embodiment, the image data 40 in which only the text characters “AB” and “CD” were aligned and drawn in the upper left portion in the vertical direction (the sub scanning direction), i.e., the image data 40 in which the image to be drawn was aggregated in the upper left portion, was described as an example. However, the image to be output and printed is not limited to this image data 40. For example, image data that is long in the horizontal direction, such as a ruled line that extends in the main scanning direction, can be output and printed. When the addresses are rearranged and the aforementioned processes performed with respect to this type of image data, the cache hit ratio will reduced even more.

Accordingly, in the third embodiment, the type of image data in the band region for which the drawing process will be performed is determined based upon various data included in the intermediate language data that was input in the intermediate language interpreting unit 21. As a result of this determination, when the image data in the band region is determined to be long in the horizontal direction, such as a long ruled line that extends in the main scanning direction, i.e., when the image data in the band region is determined to be image data in which there will be a large number of cache processes performed in the drawing process when the address rearrangement process of the present invention is performed (see step S40 in FIG. 4), the drawing process will be performed with a heretofore known method without conducting the address rearrangement process. In contrast, when the image data in the band region is determined to be aggregated to a certain degree, and it is determined that a large number of cache process will be performed with a heretofore known technique, the drawing process will be performed after the address rearrangement process described in the first embodiment.

Therefore, the speed of the drawing process can be increased even if different types of image data are drawn.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image processing device that converts one page of print data expressed in a predetermined language into band intermediate language data for each of a plurality of band regions, and outputs output image data that is created based on the converted band intermediate language data, comprising:
a data storage unit having a drawing region in which output image data corresponding to at least one band region is stored;
an address rearrangement unit that rearranges the addresses of the drawing region based on a predetermined rule; and
an output image data creation storage unit that creates the output image data based on the band intermediate language data and sequentially stores the created output image data in single word units in the drawing region whose addresses are rearranged by the address rearrangement unit.

2. The image processing device according to claim 1, wherein the address rearrangement unit rearranges an address matrix in a main scanning direction in the drawing region to an address matrix in a sub scanning direction in the drawing region so that output image data can be sequentially allocated and stored by the word in the drawing region in the sub scanning direction by means of the output image data creation storage unit.

3. The image processing device according to claim 1, further comprising a high-speed data storage unit that has a storage capacity smaller than a storage capacity of the data storage unit and capable of high-speed data access; and
wherein the output image data creation storage unit temporarily stores the created output image data in the high-speed data storage unit in each storage capacity unit of the high-speed data storage unit, and further stores output image data stored in the high-speed data storage unit in the drawing region.

4. The image processing device according to claim 2, further comprising a high-speed data storage unit that has a storage capacity smaller than a storage capacity of the data storage unit and capable of high-speed data access; and
wherein the output image data creation storage unit temporarily stores the created output image data in the high-speed data storage unit in each storage capacity unit of the high-speed data storage unit, and further stores output image data stored in the high-speed data storage unit in the drawing region.

5. An image processing method performed in an image processing device that converts one page of print data expressed in a predetermined language into band intermediate language data for each of a plurality of band regions, and outputs output image data created based on the converted band intermediate language data, comprising the steps of:
storing output image data corresponding to at least one band region in a drawing region;
rearranging the addresses of the drawing region based on a predetermined rule; and
creating the output image data based on the band intermediate language data and sequentially storing the created output image data in single word units in the drawing region whose address is rearranged by the address rearrangement unit.
